(19) United States
(12) Patent Application Publication
(10) Pub. No.: US 2025/0074685 A1
(43) Pub. Date: Mar. 6, 2025

(54) PACKAGING FILLER

(71) Applicant: Ga-hyung RHEE, Seoul (KR)

(72) Inventor: Ga-hyung RHEE, Seoul (KR)

(21) Appl. No.: 18/708,572

(22) PCT Filed: Nov. 8, 2022
(86) PCT No.: PCT/KR2022/017397

§ 371 Date: Nov. 25, 2024

(30) Foreign Application Priority Data
Nov. 14, 2021 (KR) 10-2021-0156186

(51) Int. Cl. B65D 81/127

(52) U.S. Cl. CPC B65D 81/127; B65D 2581/053

(57) ABSTRACT

Provided is a packaging filler formed from paper or corrugated cardboard rather than synthetic resins such as air caps, which is able to be recycled and yet be elastic in various directions as conventional fillers made from synthetic resins. The packaging filler includes an inner linerboard sheet and an outer linerboard sheet having a plurality of perforated holes, wherein the outer linerboard sheet includes at least one elastic unit having a protruding elastic section formed in one of regions between the perforated holes, and a support section extending from the elastic section and bonded at a distal end thereof onto the inner linerboard sheet to support the elastic section.

### TECHNICAL FIELD

The present disclosure relates to a packaging filler and, more particularly to, a packaging filler formed from paper or corrugated cardboard rather than synthetic resins such as air caps, which may be recycled and yet be elastic in various directions as conventional fillers made from synthetic resins.

### BACKGROUND ART

Corrugated cardboard is used to protect items when transporting or delivering the items. Corrugated cardboard has a structure in which a fluted corrugated cardboard core in the form of folds is attached between two flat linerboards, which structure acts as a cushion against the weight of the items and external shocks.

Corrugated cardboard has a structure in which the fluted corrugated core located between two linerboards provides elasticity to the external force applied from the two linerboards, but when the linerboards are folded or bent, the linerboards themselves, which exert elastic damping force along with the corrugated core, are damaged, making it difficult to expect their role. In addition, the linerboards are resistant in the direction in which the linerboards support an item, but the linerboards become less resistant when bent or flexed, so the linerboards are usually arranged parallel to an inner circumference of a storage box in which an item is stored.

In response to this, rolled corrugated cardboard that may be bent in one direction has been proposed, but even though the rolled corrugated cardboard may be rolled in one direction like toilet paper, the rolled corrugated cardboard has limitations in terms of a packaging filler that fills various spaces formed between an item and a storage box because the rolled corrugated cardboard may have a shape-forming feature only in one direction.

Currently, many packaging fillers for items are made from synthetic resin, such as air caps, which fill a space created by vinyl with air. Air caps, commonly referred to as bubble wrap, are folded, bent, or bunched to fill the voids between the storage box and the item to protect the item. However, since the air caps are made by filling a space between vinyl with air, the air caps have no use after the storage box containing items is delivered and are often burned off so the air caps become a source of pollution after the item is delivered.

In regards to this problem, attempts have been made to improve the shape-forming feature of corrugated cardboard, which is an eco-friendly packaging filler, by embedding sheaths in the cardboard or making incisions in the corrugated area. This will be described with reference to FIG. 9.

Referring to FIG. 9, Related art document R1 (Korean Unexamined Patent Publication No. 10-2016-0090555) proposes a foldable frame and a manufacturing method thereof in which wide cut grooves are formed in a corrugated cardboard or synthetic resin sheet to form bending parts, and various shapes are realized using the bending parts. Related art document R1 proposes a method of providing a shape-forming feature to a corrugated cardboard (or synthetic resin sheet) by forming the bending parts to allow the cardboard into a specific shape. However, Related art document R1 provides the shape-forming feature only in the area where the cut grooves are present, and not in other areas.

Related art document R2 proposes a bendable corrugated board that provides a shape-forming feature to some extent to the corrugated board by arranging foldable slits 64 in the areas that need to be bent. Like the document R1, the document R2 also allows the corrugated cardboard to have the shape-forming feature only where the foldable slits 64 are present.

Therefore, the present applicant intends to provide a packaging filler that may be formed into various shapes and resist against external impacts even without the presence of foldable slits or cut grooves.

### DISCLOSURE

### Technical Problem

An objective of the present disclosure is to provide a packaging filler having a wide range of shape-forming feature, using environmentally friendly materials that are recyclable.

### Technical Solution

According to an embodiment of the present disclosure, the objective of the present disclosure is accomplished by a packaging filler including an inner linerboard sheet and an outer linerboard sheet having a plurality of perforated holes, wherein the outer linerboard sheet includes at least one elastic unit having a protruding elastic section formed in one of regions between the perforated holes and a support section extending from the elastic section and bonded at a distal end thereof onto the inner linerboard sheet to support the elastic section.

### Advantageous Effects

Unlike synthetic resin products such as air caps, the packaging filler according to the present disclosure is a recyclable paper material, which reduces waste and environmental pollution caused by waste incineration in the non-contact era.

In addition, the packaging filler according to the present disclosure may be folded, bent, and agglomerated in various directions to compensate for the lack of shape-forming feature of the conventional corrugated cardboard, thus replacing synthetic resin products.

### BRIEF DESCRIPTION OF DRAWINGS

FIG. 1 is a perspective view illustrating a packaging filler according to an embodiment of the present disclosure.

FIG. 2 is a front view illustrating the packaging filler illustrated in FIG. 1.

FIG. 3 is a reference view illustrating a perforated hole structure of the packaging filler.

FIG. 4 is a reference view illustrating the structure of an elastic unit formed on an outer linerboard sheet.

FIG. 5 is a perspective view illustrating the elastic unit illustrated in FIG. 4.

FIG. 6 is a side view illustrating the elastic unit illustrated in FIG. 4.

FIG. 7 is a reference view illustrating a method of implementing elasticity in the packaging filler according to the embodiment of the present disclosure.

FIG. 8 is a perspective view illustrating an inner linerboard sheet according to another embodiment of the present disclosure.

FIG. 9 illustrates related art.

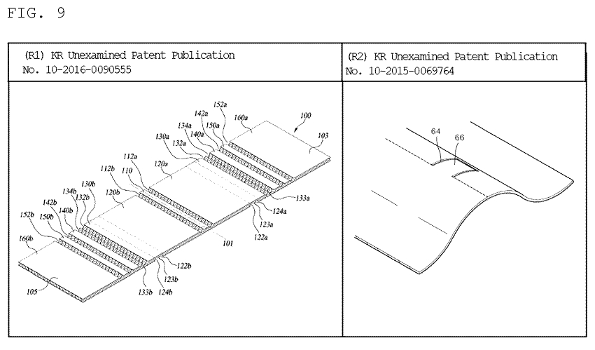

FIG. 10 shows an example of an elastic unit in which adhesive portions S12 of the elastic unit S illustrated in FIG. 4.

### DESCRIPTION OF REFERENCE NUMERALS OF DRAWINGS

S0: Elastic section S1: Support section
S11: Extension S12: Adhesive portion

### MODE FOR INVENTION

Hereinafter, the present disclosure will be described in detail with reference to the drawings.

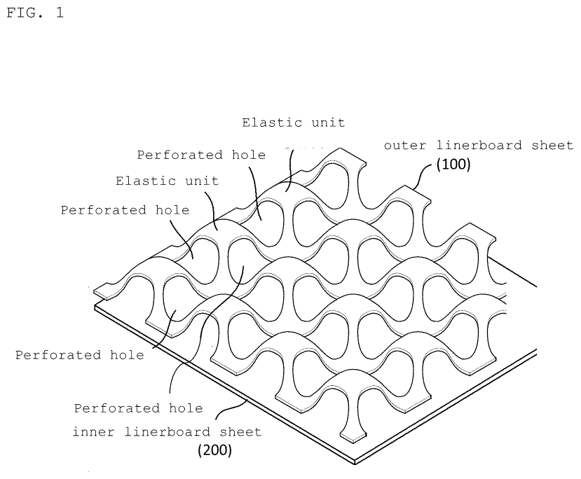

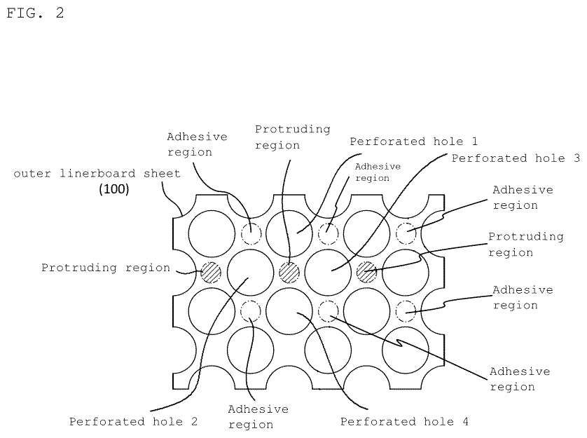

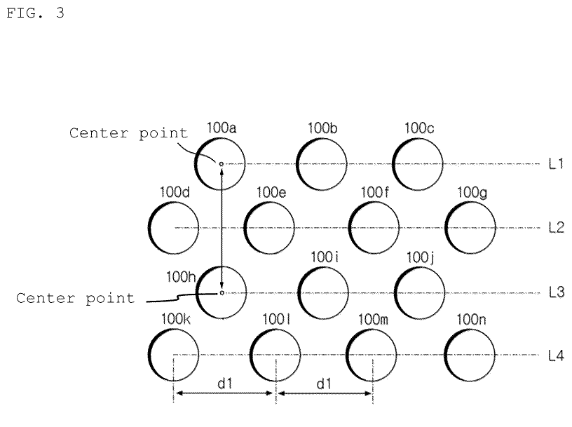

FIG. 1 is a perspective view illustrating a packaging filler according to an embodiment of the present disclosure, FIG. 2 is a front view illustrating the packaging filler illustrated in FIG. 1, and FIG. 3 is a reference view illustrating a perforated hole structure of the packaging filler.

Referring to FIGS. 1 to 3 together, a packaging filler according to an embodiment includes an outer linerboard sheet 100 and an inner linerboard sheet 200, wherein a region of the outer linerboard sheet 100 is bonded and secured to the inner linerboard sheet 200.

The outer linerboard sheet 100 and the inner linerboard sheet 200 may be any of the following materials: corrugated cardboard, single-sided corrugated cardboard, double-sided corrugated cardboard, bi-corrugated cardboard, packaging board, micro-corrugated cardboard, kraft paper, and hardboard paper. Various other materials may also be utilized, and the materials of the outer linerboard sheet 100 and the inner linerboard sheet 200 are not limited to the materials mentioned above. The thickness of the outer linerboard sheet 100 and the inner linerboard sheet 200 is determined by the weight and size of an item to be supported, and the thickness of the outer linerboard sheet 100 and the inner linerboard sheet 200 is not specifically mentioned in the present disclosure.

Between the perforated holes formed in the outer linerboard sheet 100, a protruding region is formed. For example, in FIG. 2, the space between perforated hole 1, perforated hole 2, perforated hole 3, and perforated hole 4 is raised to form a “protruding region” when the spacing between the perforated holes (perforated hole 1 to perforated hole 4) is narrowed.

The protruding regions are formed in rows along the transverse or longitudinal direction in FIG. 2, and adhesive regions are also formed in rows adjacent to the protruding regions, so that the protruding regions and the adhesive regions may be formed alternately. Here, the protruding regions may be pressed in the direction of the inner linerboard sheet 200 when an external force is applied, thereby imparting elasticity to the outer linerboard sheet 100.

The protruding regions are herein referred to as “elastic units”.

When the inner linerboard sheet 200 forms a base layer of the packaging filler according to an embodiment, the outer linerboard sheet 100 is bonded in some regions to the inner linerboard sheet to form a fixed structure so that the inner linerboard sheet is able to support external forces exerted from the outer linerboard sheet 100.

The outer linerboard sheet 100 is formed to protrude from the inner linerboard sheet 200. The outer linerboard sheet 100 includes a plurality of perforated holes, and regions between the perforated holes protrude from the inner linerboard sheet 200 to form an elastic unit. When the elastic unit is applied with an external force, the elastic unit transmits the external force to the inner linerboard sheet 200 to make the outer linerboard sheet 100 elastic. In order to uniformly form a plurality of elastic units on the outer linerboard sheet 100, the perforated holes are characterized by a regular and repeated arrangement. This will be described with reference to FIG. 3.

Referring to FIG. 3, the outer linerboard sheet 100 includes a plurality of perforated holes 100a to 100n having a uniform pitch d1. Although the perforated holes 100a to 100n are arranged with uniform pitch, the perforated holes are arranged not in a vertical grid structure, but in a mutually-staggered manner.

FIG. 3 illustrates an example in which the perforated holes 100a, 100b, and 100c are arranged in column L1, the perforated holes 100d to 100g are arranged in column L2, the perforated holes 100h to 100j are arranged in column L3, and the perforated holes 100k to 100n are arranged side by side in column L4.

Respective perforated holes in columns L1 and L3 have center points that are vertically aligned with each other. For example, the center points of perforated hole 100a in column L1 and perforated hole 100h in column L3 are vertically aligned with each other. However, the center points of perforated hole 100a in column L1 and perforated holes 100d, 100e in column L2 do not coincide vertically.

On the other hand, the center points of the perforated holes in columns L2 and L4 also coincide vertically.

Although column L1 and column L2 are each arranged horizontally with the same pitch d1, the perforated holes 100a and 100d are not located on the same vertical line, and the vertical position of the perforated hole 100a of column L1 is located between the perforated holes 100d and 100e of column L2. In other words, each of column L1 and column L2 is arranged parallel, but the respective perforated holes belonging to column L1 and column L2 are arranged staggered from each other.

As such, if columns L1 and L3 with the relationship of matching center point positions are arranged alternately with columns L2 and L4, the center points of the respective perforated holes in the odd columns (e.g., L1, L3) and the even columns (e.g., L2, L4) are vertically aligned and repeatedly formed with the same pattern, as illustrated in FIG. 3.

By utilizing this patterned structure of columns L1, L2, and L3, the regions remaining between the perforated holes in the outer linerboard sheet 100 may form an elastic unit protruding from the outer linerboard sheet 100.

The outer linerboard sheet 100 having the above-mentioned arrangement structure of perforated holes is bonded onto the inner linerboard sheet 200 in the remaining regions except for the protruding region, and the outer linerboard sheet 100 and the inner linerboard sheet 200 form an elastic body that resists external forces to form a single structure. In this case, glue, casein adhesive, vinyl acetate adhesive, starch, vinyl chloride adhesive, epoxy adhesive, etc. may be used as an adhesive for bonding the outer linerboard sheet 100 and the inner linerboard sheet 200, but various other adhesives may be applied depending on the load of the item to be supported and the direction in which the load is applied. However, the adhesive is not limited thereto.

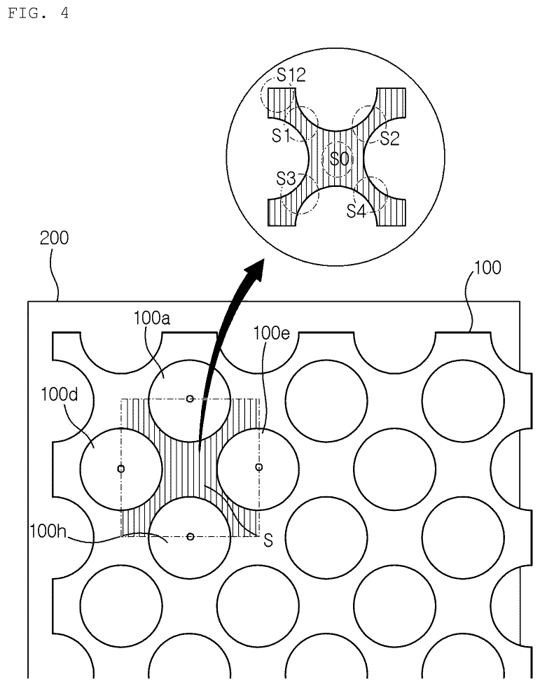

FIG. 4 is a reference view illustrating the structure of an elastic unit formed on an outer linerboard sheet.

Referring to FIG. 4, the elastic unit of the packaging filler according to an embodiment is formed in the region between the perforated holes 100a to 100h.

In FIG. 4, the elastic unit S is formed in the region enclosed by the perforated holes 100a, 100d, 100e, and 100h. The region between the perforated holes 100a and 100d forms a support section S1 of the elastic unit S. A distal end of the support section may be bonded to the inner linerboard sheet 200 to bond and secure the elastic unit S to the inner linerboard sheet 200. Similarly, support sections S2, S3, and S4 are formed in the region between the perforated holes 100a and 100e, the region between the perforated holes 100d and 100h, and the region between the perforated holes 100e and 100h, respectively.

One elastic unit S includes four support sections S1 to S4, which firmly support the area between the inner linerboard sheet 200 and the protruding elastic section S0. When an external force is applied to the elastic section S0, the four support sections S1 to S4 may support the elastic section S0 while resisting against the external force.

On the other hand, the elastic unit S may be simplified in shape to improve productivity.

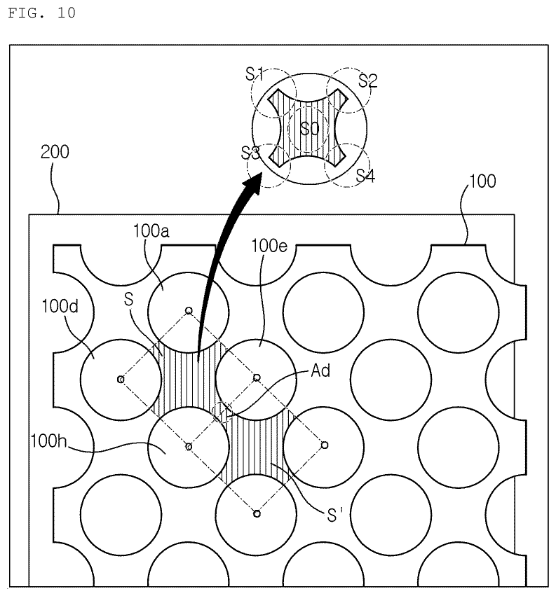

FIG. 10 shows an example of an elastic unit in which adhesive portions S12 of the elastic unit S illustrated in FIG. 4 are omitted and the distal ends of the support sections S1 to S4 are formed with adhesive portions Ad.

As shown in FIG. 10, by allowing the distal ends of the support sections S1 to S4 to be bonded onto the inner linerboard sheet 200, the production process may be simplified and the placement density of the neighboring elastic unit S and elastic unit S′ may be increased. The adhesive portion Ad may be formed at the boundary of the elastic unit S and the elastic unit S′. In this case, the distal ends of the support sections S1 to S4 shown in FIG. are bonded onto the inner linerboard sheet 200, so that the support sections S1 to S4 may together serve as the adhesive portions S12 of FIG. 4, which bonds to the inner linerboard sheet 200 while supporting the elastic section S0. In FIG. 10, the adhesive portion Ad corresponds to the area where the elastic unit S and the neighboring other elastic unit S′ are adjacent to each other.

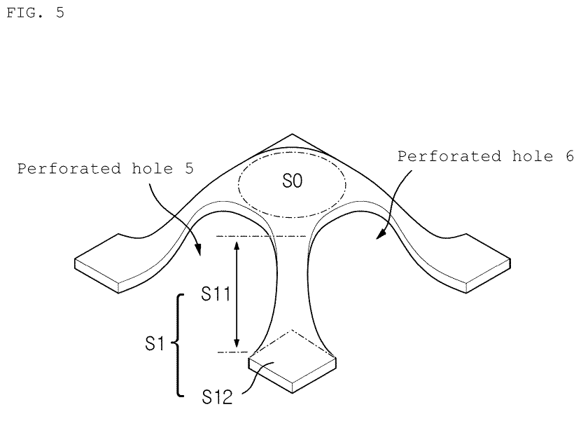

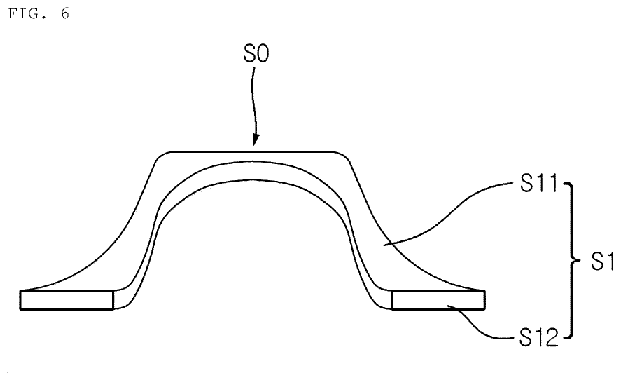

FIG. 5 is a perspective view illustrating the elastic unit illustrated in FIG. 4, and FIG. 6 is a side view illustrating the elastic unit illustrated in FIG. 4. FIGS. and 6 will be described with reference to FIGS. 1 to 4 together.

Referring to FIGS. 5 and 6 together, an elastic unit according to an embodiment is configured such that four support sections S1 to S4 are symmetrically connected about an elastic section S0.

The four support sections S1 to S4 each include an adhesive portion that is bonded to the inner linerboard sheet 200, and an extension. For example, the support section S1 may include an adhesive portion S12 that is bonded to the inner linerboard sheet 200, and an extension S11 that is formed to extend from the elastic section S0 and whose distal end is connected to the adhesive portion S12. Here, it can be seen that the extension S11 is not formed perpendicularly from the elastic section S0 towards the inner linerboard sheet 200, but has a gently inclined surface and extends toward the inner linerboard sheet 200. Accordingly, when a load, i.e., an external force, is applied to the elastic section S0, the extension S11 will resist against the load by sinking down toward the inner linerboard sheet 200. This is due to the adhesive portion S12 located at the distal end of the extension S11 being firmly adhered to the inner linerboard sheet 200 to support the load. Since the extension S11 is formed to extend integrally from the elastic section S0, the extension will retain its shape unless broken, and since the adhesive portion S12 is fixed to the inner linerboard sheet 200, when an external force is applied to the elastic section S0, the extension will resist against the external force by sinking down toward the inner linerboard sheet 200 while retaining its shape as much as possible by the elasticity provided by the gentle inclination.

The shape of the extension S11 is determined by the shape of the remaining areas of the outer linerboard sheet 100 except for the perforated area of the perforated holes. In FIG. 5, it can be seen that the shape of the extension S11 is determined by the remaining perforated area of the perforated holes 5 and 6. If it is desired to further increase the width W of the extension S11, the width W of the extension S11 may be increased by decreasing the diameter of the perforated holes 5 and 6.

In order for the elastic section S0 to have sufficient elasticity, the support sections S1 to S4 supporting the elastic section S0 need to be firmly fixed to the inner linerboard sheet. The elasticity of the elastic section S0 depends on the elastic section being supported by the adhesive portions that are adhered to the inner linerboard sheet 200 with the gentle inclination.

For this purpose, the support sections S1 to S4 may be formed extending from the elastic section S0, and then increase in area toward the adhesive portion S12 to form a pad. The adhesive area of the adhesive portion S12 has a square shape with a larger area compared to the extension S11, so that the adhesive portion may be firmly adhered to the inner linerboard sheet 200.

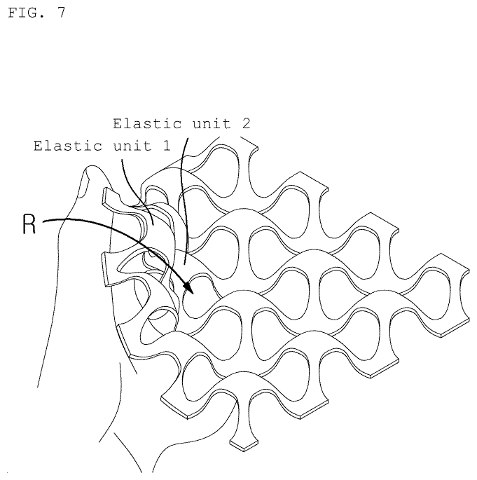

FIG. 7 is a reference view illustrating a method of implementing elasticity in the packaging filler according to the embodiment of the present disclosure.

Referring to FIG. 7, the packaging filler according to an embodiment is not oriented in a particular direction as each elastic unit protrudes between uniformly spaced perforated holes. When these non-directional elastic units are arbitrarily bent or folded by hand, the elastic units may repel each other and realize greater elasticity than when a single elastic unit is subjected to an external force.

In FIG. 7, while a user applies an external force R to the packaging filler according to the embodiment, when the elastic unit 1 moves in the direction in which the external force is applied, the elastic unit 1 may come into contact with the elastic unit 2. The elastic section of the elastic unit 1 comes into contact with the elastic section of the elastic unit 2. In this case, since the elastic sections of the elastic unit 1 and the elastic unit 2 each exert an elastic force based on the inner linerboard sheet 200, the total elastic force of the elastic unit 1 and the elastic unit 2 corresponds to the sum of the elastic forces of the elastic unit 1 and the elastic unit 2.

If the same external force R is applied to a conventional corrugated cardboard, the structure of the cardboard collapses as the cardboard crumples, but the packaging filler according to the present embodiment is characterized in that when the elastic units formed on the outer linerboard sheet 100 instead of the inner linerboard sheet 200 collide with each other, the overall elastic force increases. Accordingly, the packaging filler according to the embodiment is able to freely fill the spaces between the items in the internal space of the packaging box after the items are loaded in the internal space of the packaging box, to prevent the items from being broken. Furthermore, unlike the conventional air cap made of synthetic resin, the packaging filler according to the embodiment made of paper material is easy to recycle and reuse, and thus provides the advantage of not causing environmental pollution.

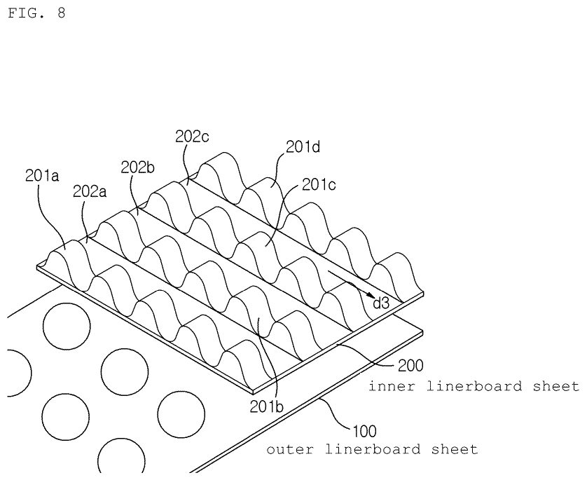

FIG. 8 is a perspective view illustrating an inner linerboard sheet according to another embodiment of the present disclosure.

Referring to FIG. 8, the inner linerboard sheet 200 according to an embodiment has a structure in which corrugated cores 201a to 201d and cut areas 201b to 201c are arranged alternately.

Each of the corrugated cores 201a to 201d of the inner linerboard sheet 200 is formed so that one side faces the outer linerboard sheet 100 and the other side is arranged opposite the outer linerboard sheet 100 and exposed to the outside. While a conventional corrugated cardboard has a structure in which a corrugated core is inserted between a pair of panels, the inner linerboard sheet 200 according to the embodiment includes a single inner linerboard sheet 200 and corrugated cores 201a to 201d attached to the inner linerboard sheet 200, wherein the corrugated cores 201a to 201d have a repeated corrugation structure and are characterized by being arranged alternately with the cut areas 202a to 202c. The cut areas 202a to 202c are shown in FIG. 8 as an example of being formed in the direction d3. However, the cut areas 202a to 202c may be formed in a direction perpendicular to d3, or may be formed diagonally across the inner linerboard sheet 200. However, the orientation of the cut areas is not limited thereto.

With the alternating arrangement of the corrugated cores 201a to 201d and the cut areas 202a to 202c, the space between the corrugated cores 201a and 201b, the space between the corrugated cores 201b and 201c, and the space between the corrugated cores 201c and 201d become an empty space.

The empty spaces formed by the cut areas 202a to 202c respectively provide spaces for the neighboring corrugated cores 201a to 201d to be accommodated. For example, the corrugated core 201a may be bent toward the corrugated core 201b and vice versa. The width of the cut areas 202a to 202c may be greater or smaller than the width of the corrugated cores 201a to 201d, but is not separately limited to a certain range.

1. A packaging filler comprising:
an outer linerboard sheet and an inner linerboard sheet having a plurality of perforated holes, wherein the outer linerboard sheet comprises at least one elastic unit including:
a protruding elastic section formed in one of regions between the perforated holes; and
a support section extending from the elastic section and bonded at a distal end thereof onto the inner linerboard sheet to support the elastic section.

2. The packaging filler of claim 1, wherein the support section is symmetrically formed around the elastic section.

3. The packaging filler of claim 1, wherein the support section comprises:
an extension formed extending from the elastic section; and
an adhesive portion bonded to the inner linerboard sheet at a distal end of the extension,
wherein the adhesive portion is in the form of a pad having an increasing area from the extension toward an adhesive region where the adhesive portion is boned onto the inner linerboard sheet.

4. The packaging filler of claim 3, wherein the extension is determined in shape by regions between the perforated holes.

5. The packaging filler of claim 1, wherein the inner linerboard sheet is provided such that a corrugated core is formed on a side opposite to the side adhering to the outer linerboard sheet, wherein the corrugated core is alternately cut in one direction into corrugated core portions and cut areas so that the corrugated core portions and the cut areas are alternately arranged.
